(19) United States
(12) Patent Application Publication
(10) Pub. No.: US 2009/0151276 A1
(43) Pub. Date: Jun. 18, 2009

(54) STORM WINDOW SYSTEM

(76) Inventor: William M. Debes, JR., Tiki Island, TX (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/274,881

(22) Filed: Nov. 20, 2008

Related U.S. Application Data
(60) Provisional application No. 60/989,304, filed on Nov. 20, 2007.

(51) Int. Cl. E06B 3/28; E06B 3/32; E06B 3/00

(52) U.S. Cl. 52/203; 49/464; 49/506

(57) ABSTRACT

Disclosed is a system and method for protecting windows from storm damage. The system can be easily installed from the inside of the windows without requiring access to the window from the outside. The system eliminates the need for ladders and various fastening devices which are typically used to install plywood over windows to protect from flying debris.

### CROSS REFERENCE TO RELATED APPLICATION

This application claims the benefit of U.S. Provisional Application No. 60/989,304, filed Nov. 20, 2007, which is incorporated by reference herein, in its entirety, for all purposes.

### TECHNICAL FIELD

This invention relates generally to window structures and, more particularly, to structures that protect windows from storm damage.

### BACKGROUND INFORMATION

Storm shutters have been around for a long time. The convenience of storm shutters is that they can be quickly secured into a protective position upon learning of an approaching storm.

One problem with storm shutters is that they are heavy structures that are permanently affixed to the building using hardware. This necessitates maintenance of the hardware because the dual forces of gravity and weather work together to degrade the integrity of the hardware and any fasteners fixing the hardware to the building and to the storm shutters.

Another problem is that most conventional implementations of storm shutters stow the shutters on the outside of the building, which leaves the shutters exposed at all times to the elements and ages them quickly. This makes maintenance of the shutters themselves an additional burden.

One alternative to storm shutters has been the use of plywood sheets. When a storm approaches, workmen fasten (typically with screws or nails) a sheet of plywood to the outside of the building over each window to protect the windows. This is effective at protecting the windows from storm damage. Once the storm passes, workmen unfasten the plywood sheets from the building.

One disadvantage of the plywood sheet approach is that it is labor intensive (particularly for windows that are not near the ground) and time consuming; it can become impossible to successfully implement if there is too little warning time or too little available labor. Another disadvantage is that over a period of years, with the passage of many storms, the repeated fastening and unfastening of the plywood sheets over the windows causes accumulated damage to the exterior of the building.

What is needed is a storm window system that protects windows from flying debris without shutters being permanently mounted on the outside of the building, and without a need to be repeatedly fixed to and removed from the building using destructive fasteners for each storm incident.

### SUMMARY OF THE INVENTION

In general terms, this storm window system provides protection to windows from flying debris.

One aspect of the storm window system is that it can be easily deployed from the inside of the windows without need to access the windows from the outside.

Another aspect of the storm window system is that it eliminates the need for ladders and various fasteners that are typically used to install plywood over windows to protect from flying debris.

Yet another aspect of the storm window system is that the protective members are not stored on the outside of the building.

It is also an aspect of the storm window system is that fasteners do not need to be affixed and removed from the exterior of the building with each storm incident.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 illustrates an embodiment of the storm window system.

FIG. 2 illustrates hooks and latches according to the storm window system affixed to a typical window frame.

FIG. 3 illustrates protective members of the storm window system in a folded configuration.

FIG. 4 illustrates partial deployment of the storm window system.

FIG. 5 illustrates an alternate embodiment implementing C-hooks to hold up the protective members.

FIG. 6 illustrates an optional embodiment where the lower protective member is held in place in the deployed position by a lower latch.

### DETAILED DESCRIPTION

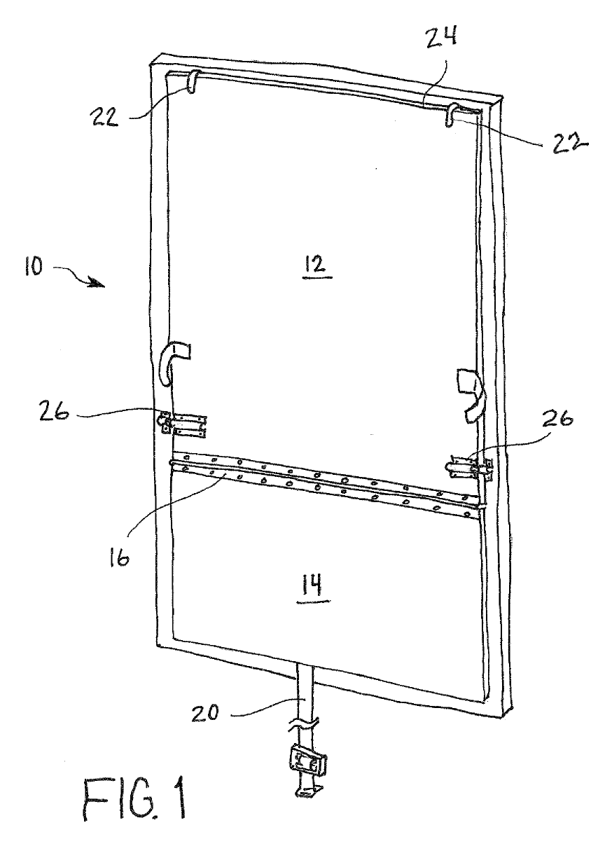

With reference to FIG. 1, the storm window system 10 according to embodiments of the present invention is shown generally. The system 10 has two protective members, a top member 12 and a bottom member 14. The two members 12, 14 are connected together by a hinge 16. According to one embodiment, the members 12, 14 are formed of a lightweight flexible plastic material strong enough to withstand high velocity impacts, so as to protect windows from flying debris. According to another embodiment, the top and bottom members 12, 14 are formed of wood products, such as but not limited to, plywood, oriented strand board, or sheets of other engineered wood products.

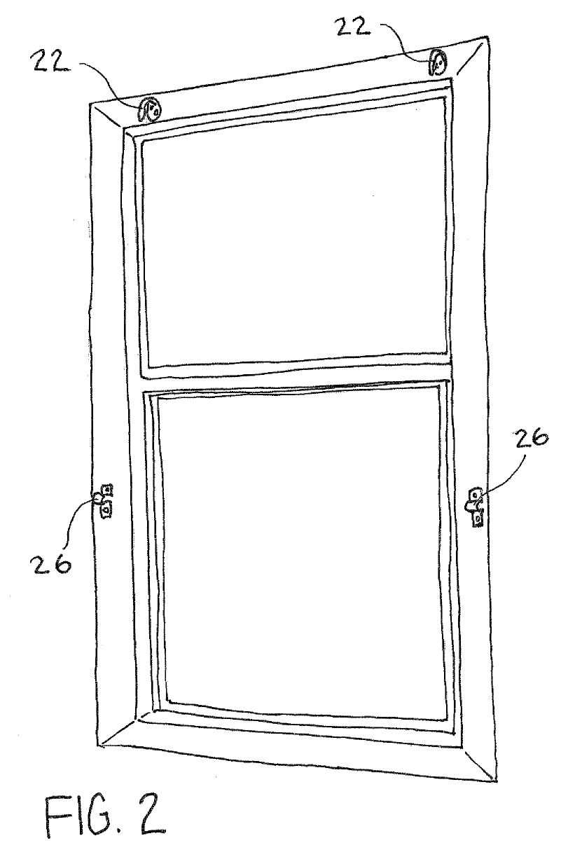

With reference to FIG. 2, a typical window is shown with hooks 22 and latches 26 according to a storm window system implementation. The hooks 22 have been permanently affixed to the top of the window frame and the latches 26 have been permanently affixed to the sides of the window frame. Although hardware is permanently affixed to the outside of the building for supporting the protective members 12, 14, the latches 26 bear the weight of the protective members 12, 14 only when deployed, not when stored. This is in contrast to the storm shutters of the prior art. With the protective members 12, 14 being stored elsewhere between storms the hardware hooks 22 and latches 26 are not subject to a constant static load and the attendant fatigue and wear.

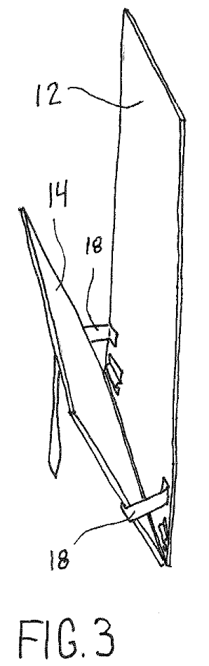

With reference to FIG. 3, the storm window system according to embodiments of the present invention is shown in its folded position with fasteners 18 holding the top and bottom protective members 12, 14 together. According to one embodiment, the fasteners 18 are Velcro® hook-and-loop type fasteners.

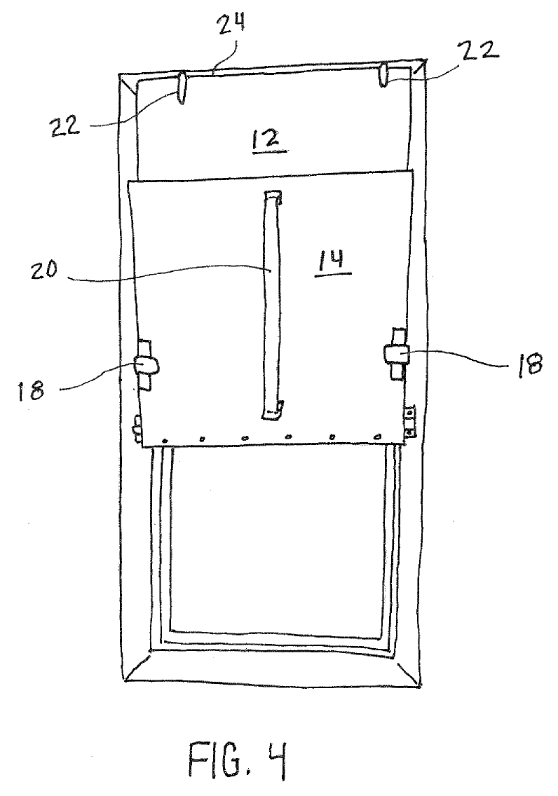

In use, the protective members 12, 14 of the system are folded as shown in FIG. 3 and then pushed outward through an opened window. With reference to FIG. 4, the storm window system 10 is shown partially deployed. From the inside of the window, the screen was removed and the folded members 12, 14 were slipped through the window. The upper edge 24 on top protective member 12 is positioned to slide under and engage the hooks 22. With the top member 12 in place and the latches 26 secured, the bottom member 14 is then unfolded into a deployed position, as shown in FIG. 1. According to one embodiment, the latches 26 have bolt protrusions that stick through slots cut into the top member 12 so that they can be latched from the inside of the window.

Once the latches 26 have been secured, the locking strap 20 is then pulled inside the window and the window lowered to retain the locking strap 20 via a frictional grip between the window and the window frame. The closed window traps the strap 20 further securing the top and bottom members 12, 14 over the window. A retaining clip on the strap 20 is then slid up the strap and secured against the bottom of the closed window to still further secure the storm window system 10 in place.

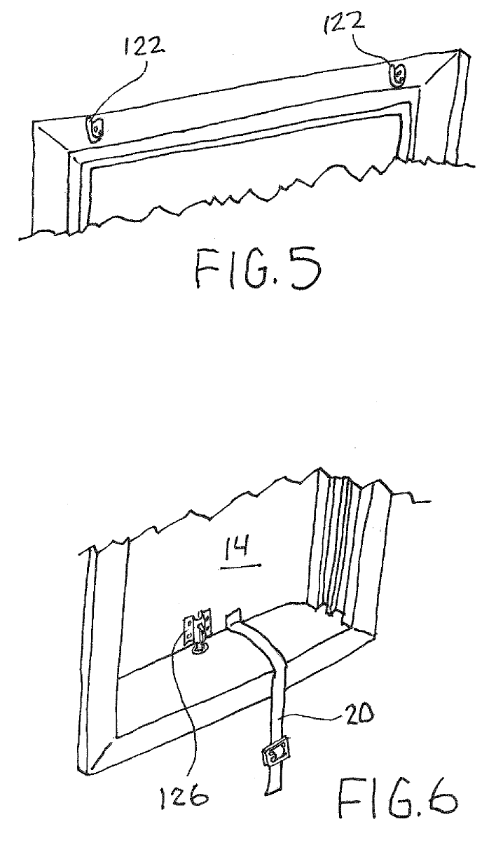

Referring to FIG. 5, in an alternate embodiment the top member 12 is held up by hooks 122 mounted to the top of the window frame. The hooks 122 are oriented pointing upward so that holes formed near the top edge of the top member 12 are sized to fit over the hooks 122 when the top member 12 is lifted into place.

Referring to FIG. 6, in an optional embodiment the lower member 14 is held in place in the deployed position by a lower latch 126 that supplements the hold of the strap 20.

As will be appreciated by those having ordinary skill in the art, the disclosed embodiments show implementation of the storm window system 10 on a window of standard configuration. The storm window system 10 of the present invention is capable of fitting standard sized windows or if desired can be custom sized to be installed on custom windows.

The storm window system of the present invention is particularly well suited for protecting windows from flying debris. It can be easily installed from the inside of the windows without having to be accessible from the outside. The system eliminates the need for ladders and various single-use fasteners which are typically used to install plywood over windows to protect from flying debris.

The top and bottom protective members 12, 14 of the system are described above as being formed of plastic material or wood products. The present invention is not limited to use of those particular materials and the protective members 12, 14 may be formed of sheet metal, expanded sheet metal, heavy gauge wire screen, carbon fiber composite, ballistic nylon (or other textiles), or combinations of the foregoing. According to one embodiment, the protective members 12, 14 are formed of a lightweight polycarbonate having outer flat sheets and an internal honeycomb structure. The perimeters of the honeycomb polycarbonate protective members 12, 14 are covered by lengths of polycarbonate channel that are cemented in place to prevent intrusion of water and wind into the internal honeycomb structure.

A method and a system for providing protection to windows have been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. A window protection system for protecting from flying debris a window that has an exterior facing frame, the system comprising:
two or more hooks permanently affixable to the frame;
one or more latches permanently affixable to the frame, each of the latches having a protrusion;
a first protective member provided with two or more openings formed therein and sized to fit onto the hooks, and provided with one or more slots formed therein and sized to accept a protrusion of a corresponding one of the latches; and
a second protective member movably affixed to the first protective member so that the protective members move with respect to one another about an axis of rotation.

2. The window protection system of claim 1, wherein the openings are formed at positions aligned with corresponding ones of the hooks, and wherein the slots are formed at positions aligned with corresponding ones of the latches.

3. The window protection system of claim 1, wherein the first protective member comprises a fastener first part and the second protective member comprises a fastener second part, the fastener first and second parts being disposed on their respective members in positions so that when the first and second protective members are moved with respect to one another about the axis of rotation into a folded position the fasteners align with one another and fasten together to hold the first and second protective members together in the folded position.

4. The window protection system of claim 3, wherein the fasteners comprise hook-and-loop type fasteners.

5. The window protection system of claim 1, further comprising a locking strap permanently affixed to a free end of the second protective member, and having a length sufficient to extend from the second protective member in through the window.

6. The window protection system of claim 5, further comprising a retaining clip disposed on the locking strap to be slidable along the locking strap and selectably secured in a fixed place on the locking strap.

7. The window protection system of claim 1, wherein the first and second protective members have a combined area sized to cover the window entirely.

8. A kit for protecting from flying debris a window that has an exterior facing frame, the kit comprising:
two or more hooks permanently affixable to the frame;
two or more latches permanently affixable to the frame, each latch having a bolt protrusion;
a first protective member sized to slide into and engage the hooks, and provided with a two or more slots formed therein and sized to accept a bolt protrusion of a corresponding one of the latches;
a second protective member movably affixed to the first protective member so that the protective members move with respect to one another about an axis of rotation;
a locking strap permanently affixed to a free end of the second protective member, and having a length sufficient to extend from the second protective member in through the window; and
a retaining clip disposed on the locking strap to be slidable along the locking strap and selectably secured in a fixed place on the locking strap;
wherein the first protective member comprises a fastener first part and the second protective member comprises a fastener second part, the fastener first and second parts being disposed on their respective members in positions so that when the first and second protective members are moved with respect to one another about the axis of rotation into a folded position the fasteners align with one another and fasten together to hold the first and second protective members together in the folded position.

9. A method for protecting from flying debris a window that has an exterior facing frame, the method comprising:
rotating a pair of hinged protective members together into a folded configuration;
pushing the folded protective members outward through an opened window;
engaging a longer one of the pair of protective members with hooks permanently affixed to a top portion of the frame, so that the protective members are supported by the frame via the hooks;
rotating a shorter one of the pair of protective members away from the longer protective member, so that the pair of hinged protective members are deployed into an unfolded configuration;
latching the longer protective member to the frame using a latch permanently affixed to a side portion of the frame;
pulling a locking strap permanently affixed to the shorter protective member inside the window;
closing the window onto the locking strap to retain the locking strap 20 via a frictional grip between the window and the frame; and
securing the locking strap in position against the closed window via a retaining clip disposed on the locking strap.

10. The method for protecting a window from flying debris of claim 9, wherein latching the longer protective member to the frame is affected by inserting a protrusion of the latch through a slot in the longer protective member.

11. A window protection system for protecting from flying debris a window that has an exterior facing frame, the system comprising:
two or more hooks permanently affixable to a top portion of the frame;
two or more latches permanently affixable to side portions of the frame, each latch having a protrusion;
a top protective member provided with two or more openings formed therein and sized to fit onto the hooks, and provided with a two or more slots formed therein and each of the slots being sized to accept a protrusion of a corresponding one of the latches;
a bottom protective member movably affixed to the first protective member by a hinge;
a locking strap permanently affixed to a free end of the bottom protective member, and having a length sufficient to extend from the bottom protective member in through the window;
a retaining clip disposed on the locking strap to be slidable along the locking strap and selectably secured in a fixed place on the locking strap; and
a fastener disposed on at least one of the top and bottom protective members to selectably retain the top and bottom protective members in a folded configuration;
wherein the top and bottom protective members have a combined area sized to cover the window entirely.

12. The window protection system of claim 11, wherein the fastener comprises a hook-and-loop type fastener.

13. The window protection system of claim 11, wherein the top and bottom protective members comprise lightweight flexible plastic material.

14. The window protection system of claim 11, wherein the top and bottom protective members comprise a wood product.
